(19) United States
(12) Patent Application Publication
(10) Pub. No.: US 2024/0209797 A1
(43) Pub. Date: Jun. 27, 2024

(54) METHOD FOR OPERATING A TURBOMACHINE FOR A FLIGHT PROPULSION DRIVE

(71) Applicant: MTU Aero Engines AG, München (DE)

(72) Inventors: Sascha Kaiser, Munich (DE); Hermann Klingels, Dachau (DE); Paul Ziegler, Munich (DE)

(73) Assignee: MTU Aero Engines AG, München (DE)

(21) Appl. No.: 18/545,289

(22) Filed: Dec. 19, 2023

(30) Foreign Application Priority Data
Dec. 21, 2022 (DE) 10 2022 134 425.8
May 17, 2023 (DE) 10 2023 113 117.6

(51) Int. Cl. F02C 9/26; B64D 27/10

(52) U.S. Cl. CPC F02C 9/26; B64D 27/10

(57) ABSTRACT

The invention is a method for operating a turbomachine for a flight propulsion drive having a compressor through which a gas stream flows in a flow direction, a combustion chamber, a turbine, and a heat exchange device situated downstream of the turbine, wherein the heat exchange device extracts water from the gas stream and the water is supplied in the combustion chamber for the combustion of fuel.

### BACKGROUND OF THE INVENTION

The invention relates to a method for operating a turbomachine for a flight propulsion drive having a compressor through which a gas stream flows in a flow direction, a combustion chamber, a turbine, and a heat exchange device situated downstream of the turbine, wherein the heat exchange device extracts water from the gas stream and the water is supplied for the combustion of fuel in the combustion chamber.

In order to diminish the impacts of air traffic on the climate, there exist efforts to reduce the most important emissions relevant to climate. Besides the known impacts of carbon dioxide emissions, non-CO₂ effects also contribute to the impacts of air traffic on climate. Non-CO₂ effects can be, for example, nitrogen oxide emissions and cirrus clouds in contrails. A highly promising concept that is based on gas turbines and takes into account all of these emissions is the water-enhanced turbofan (WET).

In the WET concept, in contrast to conventional turbofans, water is injected into the combustion chamber, as a result of which it is possible to achieve a marked reduction in the emission of nitrogen oxides. In this process, after a working medium of the turbomachine is expanded by the turbines, an exhaust gas heat is recovered at least in part by use of a heat recovery steam-generating process. A condenser with a water separator is typically used for the liquefaction and recovery of the water contained in the working medium. During the condensation, droplets form around fine dust present in the exhaust gas and it is possible to wash out these particles in the following water separator, as a result of which the fine dust emissions in the exhaust gas plume and thus also climate impacts of contrails can be reduced.

### SUMMARY OF THE INVENTION

Starting from this, an object of the present invention is to propose an improved method for operating a turbomachine for a flight propulsion drive, by which, in particular, it is possible to achieve an improved thermal efficiency for the turbomachine. This is accomplished in accordance with the invention by the teachings of the independent claims. Advantageous embodiments of the invention are the subject of the dependent claims.

In order to achieve the object, a method is proposed for operating a turbomachine for a flight propulsion drive having a compressor through which a gas stream flows in the flow direction, a combustion chamber, a turbine, and a heat exchange device situated downstream of the turbine, wherein, by the heat exchange device, water is extracted from the gas stream and is supplied for the combustion of fuel in the combustion chamber. In the process, at the outlet of the combustion chamber or downstream of the combustion chamber, there results a steam-to-gas flow ratio for the gas stream. This steam-to-gas flow ratio is adjusted depending on an operating mode of the turbomachine.

By the proposed method, the steam-to-gas flow ratio can be used to influence a turbine inlet temperature of the gas stream for various operating modes, in particular in such a way that the turbine inlet temperature for the respective various operating modes can be adjusted, changed, or adapted. For example, since more power needs to be generated or provided by the turbomachine for a takeoff or climb in the flight of an aircraft than during cruising flight operation, the temperature of the gas stream at the turbine inlet can represent a limiting factor, in particular for this case of operation. By way of the proposed adjustment of the steam-to-gas flow ratio, it is possible to influence the turbine inlet temperature for the various operating modes, so that the turbine inlet temperature can be increased for a cruising flight or cruising flight mode, without it being necessary for the turbine inlet temperature to be increased in other operating modes or operating points. The thus enabled increase of the turbine inlet temperature for a cruising flight or cruising flight mode makes it possible to increase thermal efficiency for the cruising flight or cruising flight mode of the turbomachine or an aircraft gas turbine.

Proposed in accordance with a further aspect of the invention is a turbomachine for a flight propulsion drive that is set up for use in a method proposed herein. A turbomachine is, in particular, a flight propulsion drive and typically has a fan, a compressor, a combustion chamber, and a turbine and can be designed, for example, as a turbofan engine. By the fan, it is possible to intake ambient air as a working fluid or gas stream and to compress it in the compressor for a progressive increase in pressure in the flow direction. In the combustion chamber arranged after the compressor in the flow direction of the engine, the compressed working fluid can undergo combustion with a fuel and water, in particular steam, which, by the heat exchange device, is extracted from the gas stream, in order to produce combustion gases with high pressure and high temperature. The combustion gases stream as a flow of gas from the combustion chamber to the turbine, where they expand in order to perform work. In particular, the expansion of the combustion gases in the turbine section drives a rotor shaft. It is thereby possible, for example, for a high-pressure turbine to drive a high-pressure compressor of the compressor and for a low-pressure turbine to drive the fan, whereby the low-pressure turbine can be assisted by a steam turbine.

Following the turbine, the gas stream is supplied to the heat exchange device, which can extract heat and water from the gas stream, in particular, in order to supply the water taken from this gas stream in the region of the combustion chamber, in particular upstream of the combustion chamber, to the gas stream for combustion. The heat exchanger or the heat exchange device can have, for example, a vaporizer, a condenser, and a water separator in the flow direction, through which the gas stream passes. The gas stream can thereby be precooled in the vaporizer. In the condenser, further cooling of the gas stream can condense water contained in it, whereby condensation nuclei can form on the particles (fine dust) contained in the (exhaust) gas stream. The heat exchange device can be designed here in such a way that the entire water that has been injected for the combustion can condense and again be recovered.

In the water separator, liquid water is separated from the gas stream, whereby the condensation nuclei can be washed out of the exhaust gas, thereby also reducing, in particular, the formation of contrails. The water extracted in such a way can be brought to an increased level of pressure by a pump and supplied to the vaporizer, where the water can be converted to steam by using the heat of the gas stream. Before the vaporized water is fed into the gas stream, it can be relaxed in the steam turbine, whereby the power that is thereby released can be supplied to a low-pressure shaft, in particular in order to drive the fan. The delivery of the water or steam to the gas stream or to the combustion process can increase an efficiency of the turbomachine and/or reduce the emissions of nitrogen oxides (NOx).

Upstream of the combustion chamber or after the water has been fed into the gas stream, there results, particularly for the mass flow of the gas stream, a steam-to-gas flow ratio or steam-air ratio (\dot{m}_{water}/\dot{m}ₐᵢᵣ). This steam-to-gas flow ratio yields, in particular, the steam quantity of the water supplied in relation to the air mass flow of the gas stream, in particular after the point of supply and/or before or at the inlet of the combustion chamber. Owing to the physical properties of water or steam in comparison to the compressed air of the gas stream, it is possible through an increase in the quantity of steam in relation to the air mass flow to realize a predetermined turbine power at lower turbine inlet temperature of the gas stream.

The invention is based on, among other things, the realization that, in comparison to conventional turbofans, for which a fuel throughput represents the sole degree of freedom, the steam-to-gas flow ratio in the WET concept represents an additional control variable for the turbomachine. Typically, the highest thermal loads arise for the turbomachine at the inlet of the gas stream into the turbine. An increase in the thermal efficiency through higher turbine inlet temperatures, particularly in cruising flight, is limited in the case of known or conventional aircraft gas turbines or turbomachines by turbine inlet temperatures in the case of climbing and takeoff, that is, in operating modes with higher loads.

In order to increase the thermal efficiency of an aircraft gas turbine in cruising flight through an increase in an allowable turbine inlet temperature and, in particular, without the necessity of increasing the turbine inlet temperature at other operating points, it is now further proposed to design the steam-to-gas flow ratio to be adjustable depending on the operating mode and/or the power that is to be supplied by the turbomachine. Overall, it is possible by the proposed method to achieve an increase in the thermal efficiency through higher turbine inlet temperatures in cruising flight, because the thermal limitation or possible overload at the turbine inlet in the climbing mode and/or the takeoff mode can be moderated by the reduction in temperature that is made possible for the gas stream by the delivery of water.

In one embodiment, an operating mode is a takeoff mode, a climbing flight mode, a cruising flight boost mode, and/or a cruising flight mode. An operating mode is thus, in particular, the mode of operation of the turbomachine that is employed for a predetermined phase of an aircraft operation or flight of an aircraft in order to supply a predetermined power or a predetermined power range for the respective phase of a flight. In each case, the operating mode is hereby characterized, in particular, by the respective operating conditions or operating states of the turbomachine for the respective phase or operating mode, such as, for example, a typical or aircraft-specific optimal flight speed or flight Mach number and/or flight altitude, (ISA) atmospheric conditions, and/or a typical or aircraft-specific optimal (net) boost of the turbomachine or of the flight propulsion drive and/or aircraft.

A cruising flight mode (cruise) is, in particular, a mode of operation in which the turbomachine is operated for the flight phase that begins when the aircraft stabilizes after a climb and that lasts until the aircraft begins to descend for a landing. A cruising flight boost mode is, in particular, a mode of operation, for which the turbomachine is operated with maximum boost at cruising flight altitude, such as, for example, at the end of the climbing flight or during a change in the cruising flight altitude. The cruising flight mode is employed, as a rule, for the greater portion of the flight, for which reason commercial aircraft and/or passenger aircraft are typically designed for an optimal power in cruising flight and/or, in particular, for their optimal travel speed and cruising flight altitude. The factors that influence the optimal flight speed and cruising flight altitude include, for example, load capacity, center of gravity of the aircraft, air temperature, and air humidity. The cruising flight altitude is, in particular, the point at which a higher ground speed is weighed against a smaller boost and a lower efficiency of the engines at higher altitudes. The Mach number of a typical cruising flight speed for a long-haul passenger aircraft is approximately Ma=0.6-0.9 and a typical cruising flight altitude for commercial aircraft lies at approximately 25,000 to 45,000 feet.

A climbing flight mode is, in particular, a mode of operation in which the turbomachine is operated for the flight phase during which the flight altitude of an aircraft above ground is increased, with an increase in altitude occurring to a predetermined level or the cruising flight altitude. The climbing phase follows, in particular, immediately after takeoff and precedes the cruising flight phase of the flight. Although a single climbing flight phase is typical, a plurality of climbing flight phases can alternate with cruising flight phases, in particular in the case of very long flights, during which the altitude is increased when the weight of the fuel that is present onboard decreases. With progressive climb, the climbing speed can decrease, because the boost decreases on account of the reduction in air density.

A takeoff mode is, in particular, a mode of operation in which the turbomachine is operated for the flight phase during which the aircraft is accelerated, leaves the ground, and ascends into the air. For aircraft that take off horizontally, this begins normally with a movement on the ground. In the takeoff mode, it is possible to utilize full power and/or a reduced power of the turbomachine in order to prolong the lifetime of the engine, to lower the maintenance costs, and to reduce noise emissions.

In the proposed method, it is therefore possible for the adjustment of the steam-to-gas flow ratio to occur simultaneously with, in consequence of, and/or continually or gradually with a change between two different operating modes, in order to adapt the steam-to-gas flow ratio in a suitable manner and thereby to reduce the temperature of the gas stream, in particular at the inlet of the turbine and/or behind the actual combustion, but upstream of the turbine.

In an embodiment, the steam-to-gas flow ratio is adjusted by the quantity of the water fed into the gas stream. To this end, it is possible, in particular in the region where the water is fed into the gas stream, to provide a regulating device, which is set up to control or to adjust the quantity or the mass flow of the water.

In an embodiment, the water is fed into the gas stream in the form of steam. To this end, the water can be vaporized in the vaporizer of the heat exchange device, for example and, in particular, brought to a predetermined temperature. Owing to the physical properties of steam in comparison to the compressed air or the gas stream, it is thereby possible to lower a turbine inlet temperature of the gas stream while keeping constant the power of the turbomachine.

In an embodiment, the steam-to-gas flow ratio employed in the takeoff mode is 101%-200%, in particular 140%-180%, particularly preferred 150%-170% of the steam-to-gas flow ratio employed in the cruising flight mode. The steam-to-gas flow ratio present in the gas stream or adjusted in the gas stream by feeding of water is thereby increased by the respective quotient or percent value in relation to the steam-to-gas flow ratio adjusted in the cruising flight mode. Owing to the water or steam fraction in the gas stream that is adjusted in this way, it is possible, particularly in the case of high turbomachine power, to lower the thermal load by way of the gas stream at the turbine inlet.

In an embodiment, the steam-to-gas flow ratio employed in climbing flight is 105%-180%, in particular 120%-170%, particularly preferred 135%-150% of the steam-to-gas flow ratio employed in cruising flight mode. In this way, it is possible to increase the turbomachine power for the climbing flight, in particular without it being necessary to increase the turbine inlet temperature. In particular, by the steam-to-gas flow ratio for the climbing flight mode or for an operation of the turbomachine during climbing flight, the turbine inlet temperature is adjusted in such a way that, in particular, an allowable turbine inlet temperature is not exceeded.

In an embodiment, the steam-to-gas flow ratio employed in the cruising flight boost mode is 101%-160%, in particular 110%-140%, particularly preferred 115%-130% of the steam-to-gas flow ratio employed in the cruising flight mode. In this way, it is possible in a suitable manner to increase the turbomachine power for the cruising flight boost mode or for an operation of the turbomachine at maximum boost at cruising flight altitude, in particular without it being necessary for the turbine inlet temperature to exceed a set limit value.

In an embodiment, during an operation in the climbing flight mode, the employed steam-to-gas flow ratio is lowered or adjusted to a lower value depending on the flight altitude, in particular proportionally, in relation to the steam-to-gas flow ratio in the takeoff mode. At cruising flight altitude, the steam-to-gas flow ratio of the cruising flight boost mode results for the climbing flight mode. For a climbing flight, since the turbomachine needs to supply a greater power than in cruising flight operation, because the proportion of the boost by which the boost of the engine exceeds the air resistance of the aircraft is utilized, it is possible for a gradual or continual decrease in the supplied steam to occur.

Further features, advantages, and possible applications of the invention ensue from the following description in conjunction with the figures. In general, it is valid that features of the various aspects and/or embodiments described herein by way of example can be combined with one another, provided this is not explicitly excluded in connection with the disclosure.

### BRIEF DESCRIPTION OF THE DRAWING FIGURES

In the following part of the description, reference is made to the figures, which are shown for illustration of specific aspects and embodiments of the present invention. It is obvious that other aspects can be used and that structural or logical changes of the illustrated embodiments are possible without leaving the scope of the present invention. The following description of the figures is therefore not to be understood as being limiting. Shown are:

FIG. 1 shows a schematic illustration of an exemplary turbomachine according to the invention for a flight propulsion drive; and

FIG. 2 shows a schematic illustration of a flow chart of a method according to the invention for operating a turbomachine for a flight propulsion drive.

### DESCRIPTION OF THE INVENTION

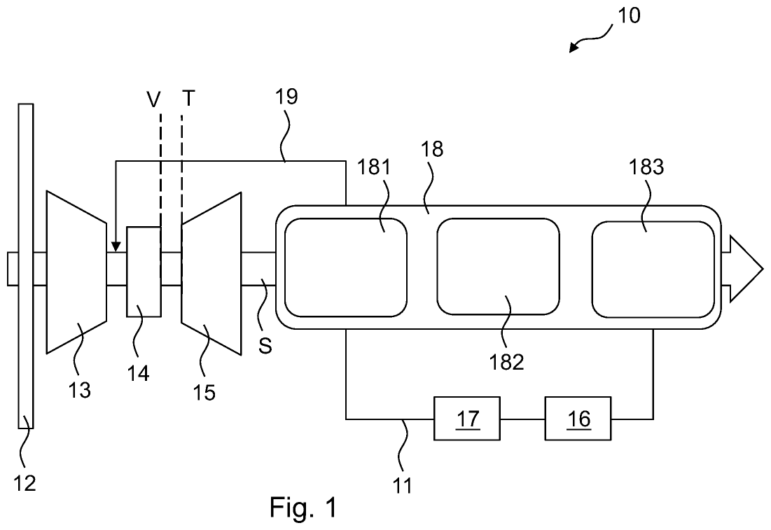

FIG. 1 shows a turbomachine 10 according to the invention for a flight propulsion drive in a schematic illustration, said turbomachine being set up to carry out the method described herein.

The turbomachine 10 can be designed as a turbofan engine, for example, and has a fan 12, a compressor 13, a combustion chamber 14, and a turbine 15, through which a gas stream S can flow in a flow direction (illustrated by the arrow depicted on the right) or through which, during an operation of the turbomachine 10, the gas stream S flows. The gas stream S here can be, for example, a core flow of the turbofan engine. In particular, the turbomachine 10 is set up to be operated in various operating modes, such as, for example, in a takeoff mode, a climbing flight mode, a cruising flight boost mode, and/or a cruising flight mode.

Downstream of the turbine 15 in the flow direction, the turbomachine 10 has a heat exchange device 18 with a vaporizer 181, which is set up to cool the gas stream S and/or to vaporize water that is extracted from the gas stream S or to generate steam by the energy of the gas stream S. This steam can be supplied via a steam feed 19, in particular together with a fuel, into the gas stream S for combustion in the combustion chamber 14, in particular by a suitable feeding device. By the water that is fed into the gas stream S, it is possible to adjust a resulting steam-to-gas flow ratio V, in particular in the flow direction at the outlet of the gas stream from the combustion chamber or upstream of the turbine.

Downstream of the vaporizer 181 in the flow direction, the heat exchange device 18 has a condenser 182 and a water separator device 183, through which the gas stream S can flow, or through which the gas stream S flows during operation of the turbomachine 10. The vaporizer 181 can be, for example, a tube bundle heat exchanger and the condenser 182 can be, for example, a crossflow plate heat exchanger, in particular with offset lamellae. The water separator device 183 can be designed, for example, as a droplet separator, which the gas stream S can set into rotation, as a result of which the water droplets thereof are conveyed radially outward by centrifugal force and the water can be collected. The remaining gas stream S can exit the turbomachine 10 via an outlet and, in particular, can be discharged to the surroundings.

The separated water can be delivered, for example, via an optionally present water processing system 16 to a water tank 17, where it can be held for further use. By a feeding device 11, the water can be supplied to the vaporizer 181 in order to generate steam, which can be fed into the gas stream S via the steam feed 19 in order to adjust the steam-to-gas flow ratio depending on an operating mode of the turbomachine 10. In this way, it is possible to influence a turbine inlet temperature T or a temperature T of the gas stream S at the turbine inlet for various operating modes, in particular in such a way that the turbine inlet temperature T for the respective various operating modes can be adjusted, changed, or adapted.

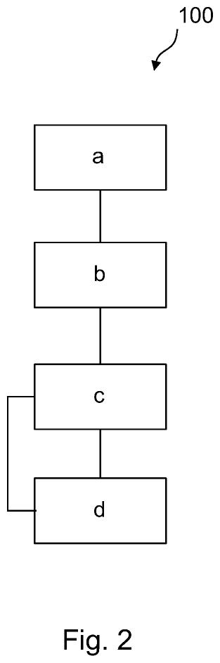

FIG. 2 shows a schematic illustration of a flow chart of an exemplary embodiment of a method 100 according to the invention for operating a turbomachine 10 for a flight propulsion drive from FIG. 1.

In a first step a, a gas stream S flows in a flow direction 10 through a compressor 13, a combustion chamber 14, a turbine 15, and a heat exchange device 18 of the turbomachine 10 situated downstream of the turbine 15. In a step b, it is thereby possible by the heat exchange device 18, to extract water from the gas stream S. In a step c, this water can be fed into the gas stream S, in particular in the form of steam, thereby resulting in a steam-to-gas flow ratio V for the gas stream S downstream or at the outlet from the combustion chamber 14.

In a step d, this steam-to-gas flow ratio V can be adjusted depending on the operating mode of the turbomachine 10, in particular by adjusting the quantity of the water that is fed into the gas stream S. Here, an operating mode can be, for example, a takeoff mode, a climbing flight mode, a cruising flight boost mode, and/or a cruising flight mode. Serving as the basis for the adjustment of the steam-to-gas flow ratio V is the steam-to-gas flow ratio V that is predetermined or set for a cruising flight mode of the turbomachine 10.

The steam-to-gas flow ratio V employed in takeoff mode can thereby be 101%-200%, in particular 140%-180%, particularly preferred 150%-170% of the steam-to-gas flow ratio employed in the cruising flight mode; the steam-to-gas flow ratio V employed in the climbing flight mode can be 105%-180%, in particular 120%-170%, particularly preferred 135%-150% of the steam-to-gas flow ratio V employed in the cruising flight mode, and the steam-to-gas flow ratio V employed in the cruising flight boost mode (maximum boost at cruising flight altitude) can be 101%-160%, in particular 110%-140%, particularly preferred 115%-130% of the steam-to-gas flow ratio V employed in the cruising flight mode. In particular, it is possible during an operation in the climbing mode for the steam-to-gas flow ratio V that is employed to be lowered depending on a flight altitude, in particular proportionally, in relation to the steam-to-gas flow ratio V in the takeoff mode.

Step d can be carried out again during a switch of the operating mode of the turbomachine, such as, for example, during a switch from takeoff mode to climbing flight mode, so that the steam-to-gas flow ratio V can be adapted or again adjusted in correspondence to the current operating mode. In this way, it is possible for each operating mode to adjust the steam-to-gas flow ratio, in particular depending on the power that is to be supplied by the turbomachine, in order to regulate and, in particular, to lower a turbine inlet temperature in the operating modes. In this way, it is possible to achieve an increase in the thermal efficiency in cruising flight, because a higher turbine inlet temperature for the cruising flight mode is made possible without exceeding an allowable maximum turbine inlet temperature in operating modes with higher power requirement.

What is claimed is:

1. A method for operating a turbomachine for a flight propulsion drive having a compressor through which a gas stream flows in a flow direction, a combustion chamber, a turbine and a heat exchange device situated downstream of the turbine, wherein, by the heat exchange device, water is extracted from the gas stream and is supplied in the combustion chamber for the combustion of fuel, wherein, at the outlet from the combustion chamber, a steam-to-gas flow ratio results for the gas stream, wherein the steam-to-gas flow ratio is adjusted depending on an operating mode of the turbomachine.

2. The method according to claim 1, wherein the operating mode is a takeoff mode, a climbing flight mode, a cruising flight boost mode, and/or a cruising flight mode.

3. The method according to claim 1, wherein the steam-to-gas flow ratio is adjusted by the quantity of the water fed into the gas stream.

4. The method according to claim 1, wherein the water is fed into the gas stream in the form of steam.

5. The method according to claim 2, wherein the steam-to-gas flow ratio employed in the takeoff mode is 101%-200% of the steam-to-gas flow ratio employed in the cruising flight mode.

6. The method according to claim 2, wherein the steam-to-gas flow ratio employed in the climbing flight mode is 105%-180% of the steam-to-gas flow ratio employed in the cruising flight mode.

7. The method according to claim 2, wherein the steam-to-gas flow ratio employed in the cruising flight boost mode is 101%-160% of the steam-to-gas flow ratio employed in the cruising flight mode.

8. The method according to claim 2, wherein the steam-to-gas flow ratio employed in the climbing mode is decreased depending on a flight altitude proportionally in relation to the steam-to-gas flow ratio employed in the takeoff mode.

9. A turbomachine for a flight propulsion drive, which is configured for use in the method according to claim 1.
